(19) United States
(12) Patent Application Publication
(10) Pub. No.: US 2013/0297358 A1
(43) Pub. Date: Nov. 7, 2013

(54) METHOD FOR INTEGRATED TICKET RESERVATION, AND TERMINAL AND SERVER THEREFOR

(71) Applicant: SAMSUNG ELECTRONICS CO., LTD., Gyeonggi-do (KR)

(72) Inventor: Hyeon-Ji KIM, Gyeongsangbuk-do (KR)

(73) Assignee: Samsung Electronics Co., Ltd., Gyeonggi-do (KR)

(21) Appl. No.: 13/875,579

(22) Filed: May 2, 2013

(30) Foreign Application Priority Data
May 2, 2012 (KR) 10-2012-0046098

(51) Int. Cl. G06Q 10/02

(52) U.S. Cl. CPC G06Q 10/02
USPC 705/5

(57) ABSTRACT

An integrated ticket reservation method allows a customer to easily inquire about the entire reservation status of ticket resellers and reserve his/her desired tickets when there are a lot of ticket resellers for one kind of ticket, and a terminal and a server therefor implement the method. The terminal requests servers to provide reservation status information including seat status information, receives the requested reservation status information from the servers, indicates seat status information included in the reservation status information from each of the servers into a full seating chart for the reservation target, and displays the full seating chart on a screen. Upon receiving a request for reservation status information for a reservation target from the terminal, the server searches a reservation database for reservation status information including seat status information indicating remaining seats for the reservation target, and transmits the searched reservation status information to the terminal.

### CLAIM OF PRIORITY

This application claims, pursuant to 35 U.S.C. §119(a), priority to and the benefit of the earlier filing date of a Korean Patent Application filed in the Korean Intellectual Property Office on May 2, 2012 and assigned Serial No. 10-2012-0046098, the entire disclosure of which is incorporated herein by reference.

### BACKGROUND OF THE INVENTION

1. Field of the Invention

The present invention relates generally to a method and apparatus for ticket reservation, and more particularly, to a method and apparatus for allowing a user to inquire about the entire seat status, designate his/her desired seats, and reserve tickets for the designated seats on a terminal over a network in real time.

2. Description of the Related Art

In the prior art, ticket reservations for various venues, stadiums, transportation, etc. may be made over a network such as the Internet. For example, a customer desiring to reserve performance tickets may visit a homepage of a ticket sales site that a ticket reseller provides on the Internet, search for a public performance that he/she wants to watch, and reserve tickets for his/her desired seats among the remaining seats for the searched public performance.

In most cases, there are a lot of ticket resellers for one public performance and tickets for a public performance slated for specific date and time are distributed to the ticket resellers so that the ticket resellers may sell tickets for different seats. In this case, while one ticket reseller has no remaining seats, other ticket resellers may have remaining seats. Even though a certain ticket reseller has some remaining seats, such a ticket reseller may not have the specific remaining seats, such as the class or positions of which the customer wants. In addition, the ticket resellers may have different sales conditions such as price and discount conditions of seats.

Accordingly, to find his/her favorite or preferred seats among all the remaining seats, the customer is inconveniently required to visit several ticket sales sites one by one, check reservation status information of each of the ticket sales sites, and compare sales conditions between the ticket sales sites.

In some cases, however, tickets for all seats for one public performance may be sold in common by a plurality of ticket resellers without being distributed to specific ticket resellers. In this case, users may not be able to check the entire reservation status, if a reservation status of a certain ticket reseller is not updated along with other ticket resellers in real time. In addition, a customer may still not be able to compare sales conditions of one ticket reseller with those of other ticket resellers if he/she visits only one ticket reseller.

### SUMMARY OF THE INVENTION

An aspect of an exemplary embodiment of the present invention is to provide an integrated ticket reservation method for allowing a customer to easily inquire about the entire reservation status when there are a lot of ticket resellers for one kind of ticket, and a terminal and a server therefor.

Another aspect of an exemplary embodiment of the present invention is to provide an integrated ticket reservation method for allowing a customer to easily select the seats meeting his/her desired conditions and reserve tickets for the selected seats when there are a lot of ticket resellers for one kind of ticket, and a terminal and a server therefor.

Another aspect of an exemplary embodiment of the present invention is to provide an integrated ticket reservation method for allowing a customer to easily check sales conditions of ticket resellers when there are a lot of ticket resellers for one kind of ticket, and a terminal and a server therefor.

In accordance with one aspect of the present invention, there is provided a method for integrated ticket reservation in a terminal The method includes receiving reservation target information for a reservation target from a user; requesting a plurality of servers of preset ticket sales sites to provide reservation status information corresponding to the reservation target information; receiving, from the servers, reservation status information including seat status information indicating remaining seats for the reservation target; integrating seat status information included in reservation status information from each of the servers into a full seating chart for the reservation target; and displaying the full seating chart on a screen.

In accordance with another aspect of the present invention, there is provided a method for integrated ticket reservation in a server of a preset ticket sales site for integrated ticket reservation on a terminal. The method includes receiving a request for reservation status information corresponding to reservation target information for a reservation target, from the terminal; searching a reservation database for reservation status information including seat status information indicating remaining seats for the reservation target based on the reservation target information; and transmitting the searched reservation status information to the terminal.

In accordance with a further aspect of the present invention, there is provided a terminal for providing an integrated ticket reservation. The terminal includes a communication unit for communicating with a plurality of servers of preset ticket sales sites; a display; a key input unit; and a controller for requesting the servers to provide reservation status information including seat status information indicating remaining seats for a reservation target which is input by a user on the key input unit, receiving the requested reservation status information through the communication unit, integrating seat status information included in reservation status information from each of the servers into a seating chart for the reservation target, and displaying the seating chart on a screen of the display.

In accordance with yet another aspect of the present invention, there is provided a server of a preset ticket sales site for integrated ticket reservation on a terminal The server includes a communication unit for communicating with the terminal; a reservation database for storing reservation status information for a reservation target; and a controller for, upon receiving a request for reservation status information corresponding to reservation target information for the reservation target from the terminal through the communication unit, searching the reservation database for reservation status information including seat status information indicating remaining seats for the reservation target based on the reservation target information, and transmitting the searched reservation status information to the terminal through the communication unit.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 shows an architecture of an integrated ticket reservation system according to an exemplary embodiment of the present invention;

FIG. 2 is a block diagram of a terminal according to the exemplary embodiment of the present invention;

FIG. 3 is a flow diagram of an integrated ticket reservation method performed in a terminal according to the exemplary embodiment of the present invention;

FIG. 4 is a block diagram of a server of a ticket sales site according to the exemplary embodiment of the present invention;

FIG. 5 is a flow diagram of an integrated ticket reservation method performed in a server of a ticket sales site according to the exemplary embodiment of the present invention; and

FIGS. 6A, 6B, and 6C show examples of a full seating chart according to the exemplary embodiment of the present invention.

Throughout the drawings, the same drawing reference numerals will be understood to refer to the same elements, features and structures.

### DETAILED DESCRIPTION OF THE INVENTION

Preferred exemplary embodiments of the present invention will now be described in detail with reference to the accompanying drawings. In the following description, specific details such as detailed configurations and components are merely provided to assist the person of ordinary skill in the art with an overall understanding of the exemplary embodiments of the present invention. Therefore, a person of ordinary skill in the art should appreciate that various changes and modifications of the exemplary embodiments described herein can be made without departing from the scope and spirit of the invention, as defined by the appended claims In addition, descriptions of well-known functions and constructions may be omitted for clarity and conciseness when their inclusion might obscure appreciation of the subject matter of the present invention by an artisan.

Also, terms described herein, which are defined considering the functions of the present invention, may be implemented differently depending on user and operator's intention and practice. Therefore, the terms should be understood on the basis of the disclosure throughout the specification. The principles and features of this invention may be employed in varied and numerous embodiments without departing from the scope of the invention.

Furthermore, although the drawings represent exemplary embodiments of the invention, the drawings are not necessarily to scale and certain features may be exaggerated or omitted in order to more clearly illustrate and explain the present invention.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet PC, a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

Among the terms set forth herein, an icon refers to a graphical element such as a figure or a symbol displayed on the screen of the device such that a user can easily select a desired function or data. In particular, each icon has a mapping relation with any function being executable in the device or with any data stored in the device and is used for processing functions or selecting data in the device. When a user selects one of the displayed icons, the device identifies a particular function or data associated with the selected icon. Then the device executes the identified function or displays the identified data.

Among terms set forth herein, data refers to any kind of information processed by the device, including text and/or images received from any external entities, messages transmitted or received, and information created when a specific function is executed by the device.

Although exemplary embodiments of the present invention will be described below with reference to a mobile terminal by way of example, the exemplary embodiments of the present invention may be applied to other devices having similar technical backgrounds. In addition, the exemplary embodiments of the present invention may be applied to other devices with slight modifications by those of ordinary skill in the art without departing from the spirit and scope of the invention. In other words, the exemplary embodiment of the present invention may be applied to any terminals even if such terminals are not mobile terminals as long as such terminals can access a ticket sales site and reserve tickets over a network such as the Internet. For example, the present invention may be applied not only to desktop computers and smart Televisions (TVs), but also to various portable electronic devices, such as MPEG-1 Audio Layer-3 (MP3) players, Portable Multimedia Players (PMPs), and digital cameras, as long as such electronic devices have an Internet access function.

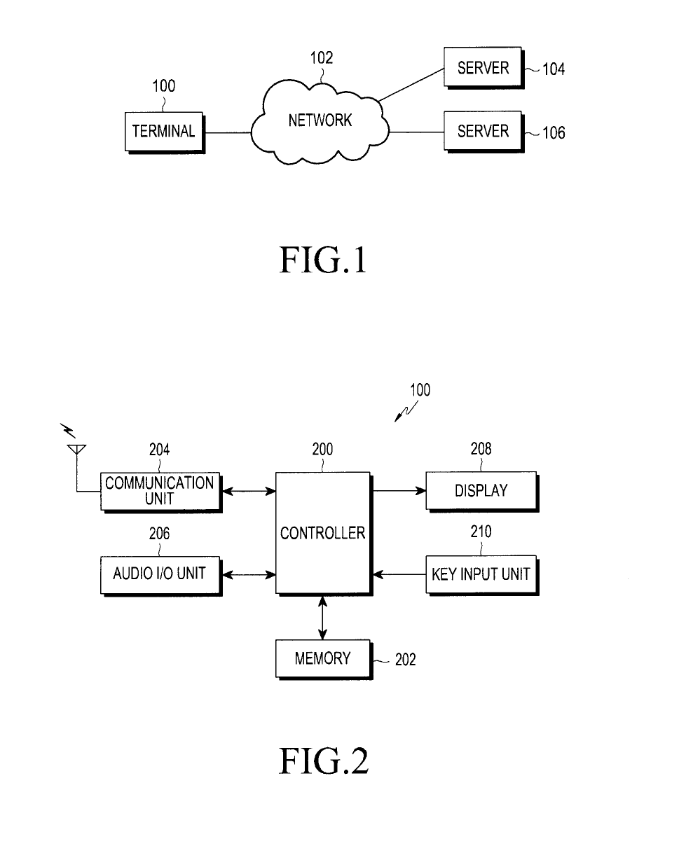

FIG. 1 shows an architecture of an integrated ticket reservation system according to the exemplary embodiment of the present invention. Referring to FIG. 1, a terminal 100 may access, for example, servers 104 and 106 over a network 102 by wire/wireless communication; that is, a communication method which utilizes wire connections and/or wireless connections. The network 102 may be a network that provides wire/wireless Internet services. The servers 104 and 106 are servers for storing and providing access to ticket sales sites that different ticket resellers provide. For convenience, in the example of FIG. 1, the terminal 100 may access two servers 104 and 106, but the number of servers of ticket sales sites that the terminal 100 may access is not limited to two servers, and may vary.

The servers that the terminal 100 will access for the integrated ticket reservation of the present invention may be selectively set in advance by a user of the terminal 100, or may be set by default. When the integrated ticket reservation method of the present invention is provided as an application, the servers that the terminal 100 will access may be set by default by an application provider or developer. In the following description, in an illustrative example, two servers 104 and 106 are set in the terminal 100 as servers that the terminal 100 will access for the integrated ticket reservation.

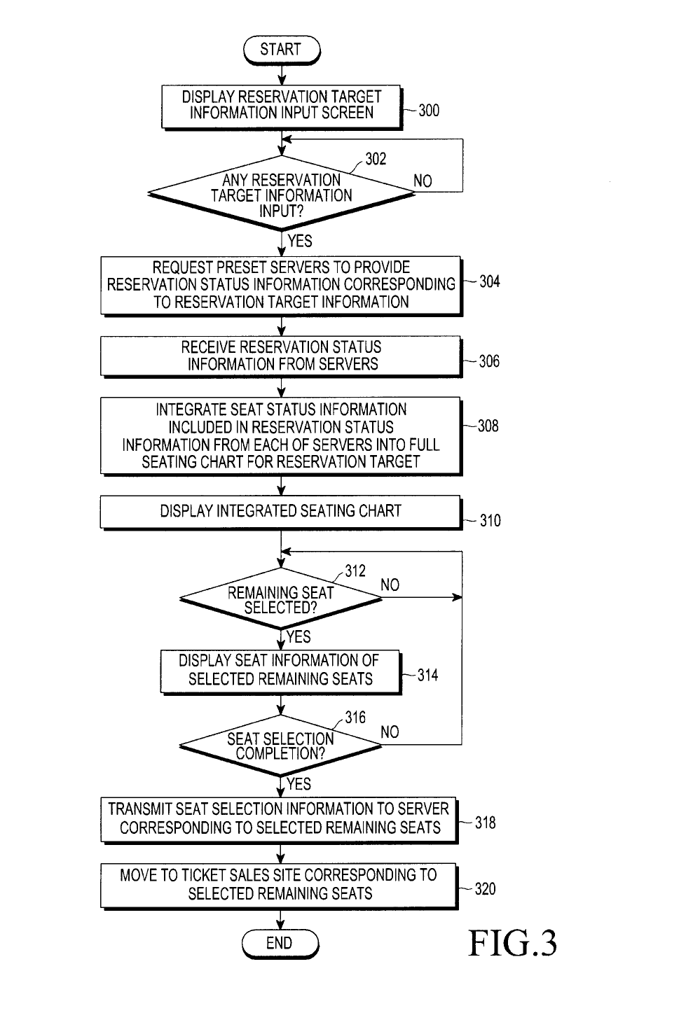

FIG. 2 is a block diagram of a terminal according to the exemplary embodiment of the present invention, in which a structure of a mobile terminal is shown as an example of a structure of the terminal 100 shown in FIG. 1. The terminal 100 shown in FIG. 2 may be one of, for example, a laptop computer, a tablet computer, a mobile phone, a smart phone, and a Personal Digital Assistant (PDA). Referring to FIG. 2, the terminal 100 includes a controller 200, a memory 202, a communication unit 204, an audio Input/Output (I/O) unit 206, a display 208, and a key input unit 210. In the mobile terminal shown in FIG. 2, to which the present invention is applicable, components other than the components directly involved in the ticket reservation, but which provide other functions for the mobile terminal, are not shown.

The memory 202 stores a program for an operation of the controller 200, and also stores various data generated during execution of the controller 200. The memory 202 may store a program that is executed by the controller 200 for the integrated ticket reservation method of the present invention. The memory 202 may further include an external memory, and may also include a storage device such as Hard Disk Drive (HDD).

The communication unit 204, under control of the controller 200, may provide communication functions for various communication services of the terminal 100, and may also provide communication functions for the servers 104 and 106 over the network 102 in FIG. 1. In this case, the network 102 is a network that provides, for example, wireless Internet communication. The communication unit 204 includes a mobile communication component, and may further include wire/wireless communication components such as a Universal Serial Bus (USB), a Local Area Network (LAN), and a component implementing or compatible with “BLUETOOTH”, a short range wireless communications technology at the 2.4 GHz band, commercially available from the “BLUETOOTH SPECIAL INTEREST GROUP, INC.”.

The audio I/O unit 206 inputs and outputs various sounds, such as voice or audio from audio files, generated by an operation of the controller 200. The display 208 displays images generated by an operation of the controller 200.

The key input unit 210 provides various key inputs, entered for an operation of the terminal 100 from the user, to the controller 200. The key input unit 210 may include a touch screen panel mounted on or included in the display 208 for accessing a graphic user interface (GUI) of the terminal 100, for example, by clicking or tapping an icon, and may also include numeric/character keys for inputting numeric/character information and function keys for setting various functions. The key input unit 210 may also include a mouse, a trackball, or other devices for accessing and entering information into the GUI.

The controller 200 accesses the servers 104 and 106 through the communication unit 204, to request reservation status information for a reservation target and to receive the requested reservation status information from each of the servers 104 and 106. The controller 200 integrates seat status information included in the reservation status information from each of the servers 104 and 106 into a full seating chart for the reservation target, and displays the full seating chart on a screen of the display 208, providing the integrated seat status information to the user. If the user selects remaining seats on the seating chart, the controller 200 transmits seat selection information for the selected remaining seats to a server corresponding to the selected remaining seats, and moves to a ticket sales site corresponding to the selected remaining seats; that is, the controller 200 directs the user and/or the screen on the display 208 to change the currently viewed website to the ticket sales site.

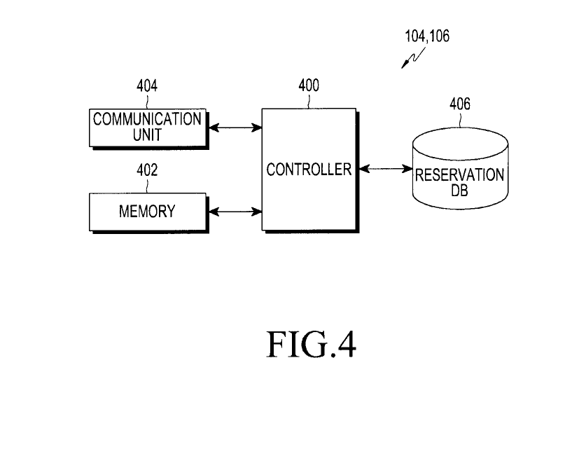

FIG. 3 is a flow diagram of an integrated ticket reservation method performed in a terminal according to the exemplary embodiment of the present invention, in which a process of an integrated ticket reservation function is performed by the controller 200 of the terminal 100 configured as shown in FIG. 2. Referring to FIG. 3, after an integrated ticket reservation function starts, the controller 200 performs step 300. If a user activates or clicks a predetermined menu or icon using the key input unit 210 to run the integrated ticket reservation function, the controller 200 starts running the integrated ticket reservation function.

In step 300, the controller 200 displays a reservation target information input screen on the display 208. Upon receiving reservation target information for a reservation target from the user through the key input unit 210 in step 302, the controller 200 proceeds to step 304. Otherwise, in step 302, if no reservation target information is received, the method loops back to step 302 to wait for input of such information. The reservation target may be a specific public performance, sports event, or transportation mode. For example, if the reservation target is a public performance, the user may input a name and date/time of the public performance, for tickets of which he/she wants to reserve, as reservation target information.

In step 304, the controller 200 accesses preset servers 104 and 106 through the communication unit 204, and requests the servers 104 and 106 to provide reservation status information corresponding to the reservation target information.

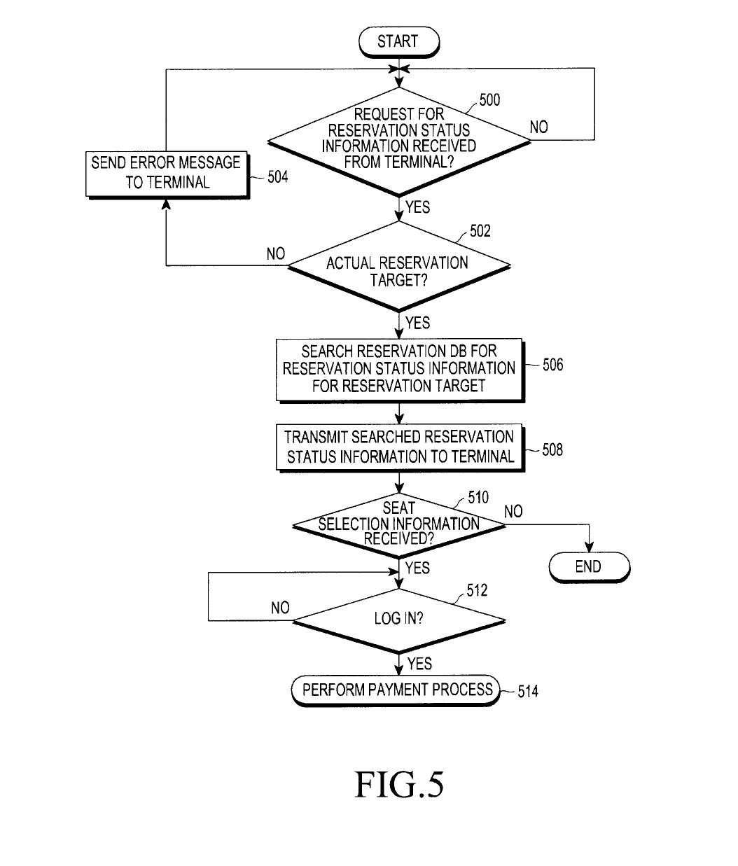

FIG. 4 is a block diagram of a server of a ticket sales site according to the exemplary embodiment of the present invention, in which an example structure of any one of the servers 104 and 106 of FIG. 1 is shown. Referring to FIG. 4, each of the servers 104 and 106 includes a controller 400, a memory 402, a communication unit 404, and a reservation database (DB) 406.

The memory 402 stores a program for an operation of the controller 400, and also stores various data generated during execution of the controller 400. The memory 402 may further include an external memory, and may also include a storage device such as a HDD. The communication unit 404 enables communication with the terminal 100 over the network 102, under control of the controller 400.

The reservation DB 406 stores reservation status information related to various reservation targets, tickets of which are sold by a ticket reseller of a related server among the servers 104 and 106. The reservation status information includes seat status information indicating remaining seats among all of the seats, tickets of which are sold by the related server for the reservation target. The seat status information is information that represents positions of the seats in coordinates on the seating chart. The coordinates may be information that represents detailed positions (e.g., floor, section, column, and seat number) of seats.

The reservation status information may further include price and discount information of each seat class for a reservation target, and may also further include the full seating chart and classes of seats for a place of the reservation target. For example, if the reservation target is a public performance, the seating chart may show all seats of the performance location, such as a performance hall, which are arranged, for example, by floors, sections, and columns. As to the classes of seats, one of a predetermined set of classes, for example, a Very Important Person (VIP) seat, a Royal (R) seat, a Superior (S) seat and an A-grade (A) seat may be assigned to each of the seats. Price and discount information for each seat class determines the price and discount information for each seat in its corresponding seat class, tickets for which are sold by a ticket reseller of a related server among the servers 104 and 106, and ticket resellers may have different price and discount information for each seat class. In an alternative embodiment to FIG. 4, the reservation DB 406 may be located outside of or remote from the servers 104 and 106.

Upon receiving a request for reservation status information for a reservation target from the terminal 100 through the communication unit 404, the controller 400 may search the reservation DB 406 for the requested reservation status information for a reservation target and transmit the searched reservation status information to the terminal 100. After receiving seat selection information from the terminal 100, the controller 400 may also optionally perform a payment process depending on the seat selection information, for example, if the user of the terminal 100 logs in to the terminal 100 and/or logs in to the corresponding one of the servers 104, 106 through the terminal 100.

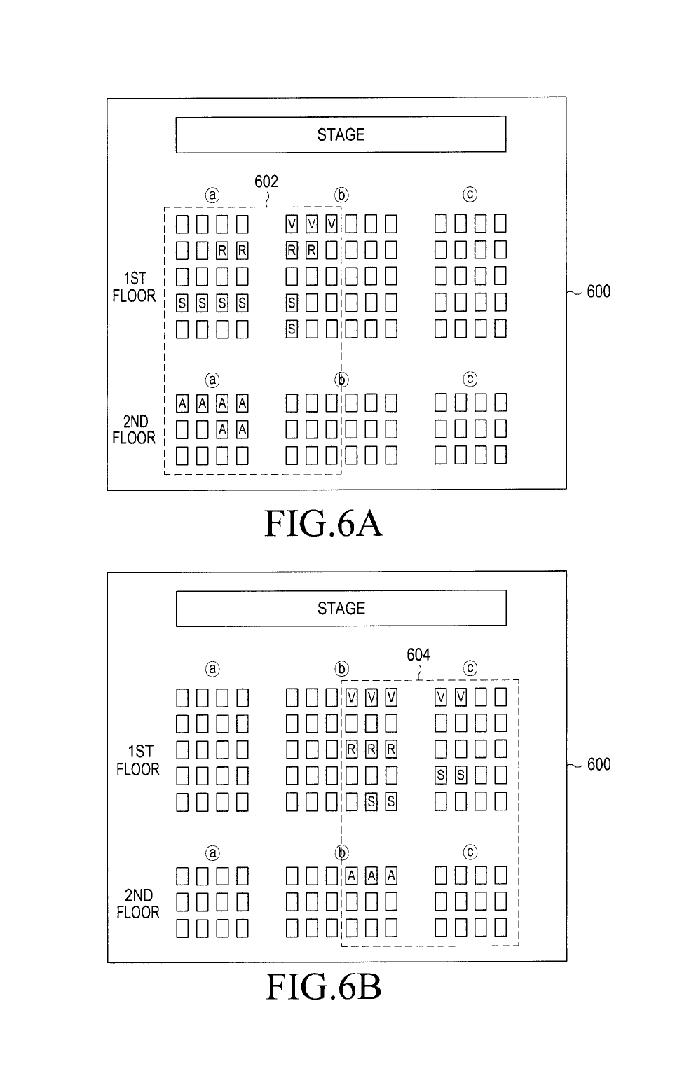

FIG. 5 is a flow diagram of an integrated ticket reservation method performed in a server of a ticket sales site according to the exemplary embodiment of the present invention, in which a process of an integrated ticket reservation function is performed by the controller 400 of each of the servers 104 and 106 configured as shown in FIG. 4. Referring to FIG. 5, upon receiving a request for reservation status information corresponding to reservation target information for a reservation target from the terminal 100 in step 500, the controller 400 proceeds to step 502. Otherwise, the method loops back to step 500 to wait for input of such a request.

In step 502, the controller 400 determines whether the requested reservation target corresponding to reservation target information is an actual or valid reservation target, corresponding to tickets for which are actually sold in a ticket sales site of a related server. The servers 104 and 106 may include a server of a ticket sales site that does not sell tickets for the reservation target, corresponding to reservation status information for which is requested by the terminal 100. If the requested reservation target is not a valid reservation target for tickets for which are actually sold on the ticket sales site of the server, the controller 400 sends an error message to the terminal 100 in step 504 and returns to step 500.

However, in step 502, if the method determines that the requested reservation target is an actual or valid reservation target, tickets for which are actually sold on the ticket sales site of the server, the controller 400 searches the reservation DB 406 for reservation status information for the requested reservation target in step 506. Next, the controller 400 transmits the searched reservation status information to the terminal 100 in step 508, and determines in step 510 whether seat selection information is received from the terminal 100. In the following description, in an illustrative example, both of the servers 104 and 106 have transmitted reservation status information to the terminal 100.

Referring back to FIG. 3, the controller 200 receives reservation status information transmitted from each of the servers 104 and 106 in step 306. Then, the controller 200 integrates seat status information included in the reservation status information received from each of the servers 104 and 106 into a full seating chart for the reservation target in step 308, and displays the integrated seating chart on a screen of the display 208 in step 310.

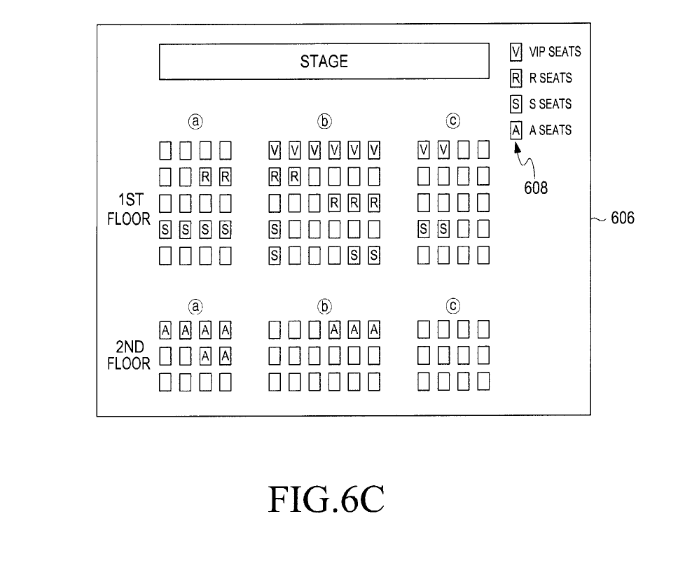

FIGS. 6A to 6C show examples of a full seating chart according to the exemplary embodiment of the present invention, in which a seating chart 600 of a public performance hall is shown, for when, in an illustrative example, the reservation target is a public performance slated for a specific date/time and tickets for all the seats for the public performance are assigned to ticket sales sites of the servers 104 and 106 on a 50/50 basis. In this illustrative example, the public performance hall has first and second floors, and each floor is divided into sections (a), (b) and (c). In FIGS. 6A to 6C, each of -shapes or box shapes represents one seat. The labels ‘V’, ‘R’, ‘S’, and ‘A’ marked on each seat represent seat classes: ‘V’ represents a VIP seat, ‘R’ represents a Royal seat, ‘S’ represents a Superior seat, and ‘A’ represents an A-Grade seat. While seats marked with ‘V’, ‘R’, ‘S’, and ‘A’ represent remaining seats, seats which are not marked with ‘V’, ‘R’, ‘S’, and ‘A’ represent sold-out seats, or seats such that tickets for which are not slotted or available in the related ticket sales site. In an alternative embodiment, the sold-out or unavailable seats may be represented by filled-in boxes, by boxes with an X therein, or by other predetermined graphical representations of sold-out or unavailable seats.

FIG. 6A shows an example of a full seating chart corresponding to reservation status information received from the server 104. FIG. 6B shows an example of a full seating chart corresponding to reservation status information received from the server 106. FIG. 6C shows an integrated seating chart displayed in step 310 of FIG. 3, in which the information from both servers 104, 106, in FIGS. 6A-6B, are combined and displayed together.

Among all the seats of the public performance hall in FIG. 6A, a half 602 of the seats shown on the left side of FIG. 6A represents seats, tickets for which are sold on the ticket sales site of the server 104. Therefore, the seat status information in the reservation status information received at the terminal 100 from the server 104 represents remaining seats among the seats 602. Similarly, among all the seats of the public performance hall in FIG. 6B, a half 604 of the seats shown on the right side of FIG. 6B represents seats, tickets for which are sold on the ticket sales site of the server 106. Therefore, the seat status information in the reservation status information received at the terminal 100 from the server 106 represents remaining seats among the seats 604.

Referring to FIG. 6C, seat status information for the seats 602 in FIG. 6A and seat status information for the seats 604 in FIG. 6B are integrated into an integrated seating chart 606. The seating chart 606 includes legends 608 for seat classes ‘V’, ‘R’, ‘S’, and ‘A’.

Therefore, even in the case where tickets for one public performance are sold on ticket sales sites of the servers 104 and 106 after being divided, reservation statuses of the ticket sales sites of the servers 104 and 106 are displayed on the integrated seating chart 606 as shown in FIG. 6C. Accordingly, the user may easily inquire about the entire reservation status by simply watching one screen, and select his/her favorite or preferred seats. Otherwise, even in the case where tickets for one public performance are sold in common on ticket sales sites of the servers 104 and 106, the user may easily inquire about the entire reservation status and select his/her favorite or preferred seats, even if a reservation status of a certain ticket reseller is not updated in the reservation systems or websites of other ticket resellers in real time.

Referring back to FIG. 3, if the user selects at least one of the remaining seats using the key input unit 210 in step 312 while the integrated seating chart 606 is displayed in step 310 as shown in FIG. 6C, the controller 200 proceeds to step 314. However, if the user does not make a selection in step 312, the method loops back to step 312 to wait for an input selection from the user. In step 314, the controller 200 displays seat information of the selected remaining seats on a screen of the display 208. The seat information may be sales conditions (e.g., price and discount information of seats) based on price and discount information for each seat class, which is included in the reservation status information. Therefore, the user may determine whether to complete the seat selection, taking into account the seat information of the selected remaining seats.

In step 316, the controller 200 checks whether ‘Seat Selection Completion’ for the remaining seats selected by the user, or any other completion indicator, is input or clicked by the user using the key input unit 210. If ‘Seat Selection Completion’ is not input, the controller 200 returns to step 312.

However, if the user inputs ‘Seat Selection Completion’ for the selected remaining seats using the key input unit 210, the controller 200 proceeds from step 316 to step 318. In step 318, the controller 200 transmits seat selection information to the server corresponding to the selected remaining seats. The seat selection information is information used to inform the corresponding server of the selected seats. Thereafter, in step 320, the controller 200 moves to the ticket sales site of the server corresponding to the selected remaining seats, i.e., the ticket sales site provided by the server corresponding to the selected remaining seats, such that the controller 200 directs the user and/or the screen on the display 208 to change the currently viewed website to the ticket sales site. Accordingly, the controller 200 displays a homepage or other appropriate web pages of the ticket sales site of the server corresponding to the selected remaining seats on a screen of the display 208.

The integrated ticket reservation process of the terminal 100 is ended after step 320, but after step 320, the controller 200 additionally performs steps corresponding to the below-described steps 512 and 514 in FIG. 5. These additionally performed steps are achieved after the terminal 100 moves to the ticket sales site.

Referring back to FIG. 5, upon receiving seat selection information from the terminal 100 in step 510, the controller 400 proceeds to step 512. However, if no seat selection information is received from the terminal 100 in step 510, the controller 400 ends the integrated ticket reservation process. In step 512, the controller 400 waits for log-in by the user of the terminal 100 that has moved to the ticket sales site of the server in step 320, and the method loops back to step 512 until the user logs in. When the user logs in as detected in step 512, the controller 400 performs a normal payment process in step 514, in which payment for the selected seats is made based on the seat selection information. The process following step 514 is substantially the same as the normal ticket reservation process known in the art, so a detailed description thereof will be omitted.

Accordingly, even though the user does not perform separate manipulations for moving to the ticket sales site of the server corresponding to the selected remaining seats among the servers 104 and 106, the terminal 100 moves to the ticket sales site of the server and displays a homepage or appropriate web page thereof on a screen of the display 208 of the terminal 100. Thereafter, if the user logs in, the terminal 100 may perform the payment process without undergoing again the seat selection process.

In some cases, there is a plurality of ticket sales sites corresponding to the selected remaining seats. In other words, the user might have selected remaining seats sold on the ticket sales site of the server 104 together with remaining seats sold on the ticket sales site of the server 106. In this case, the controller 200 transmits in sequence the seat selection information to the servers 104 and 106 corresponding to the selected remaining seats, and moves to each of the ticket sales sites of the servers 104 and 106 sequentially, or alternatively moves to both ticket sales sites concurrently; for example, using overlapping or split windows with each ticket sales site accessible simultaneously by the user. Accordingly, the user may conveniently proceed with the payment process even though there are a lot of ticket sales sites corresponding to the selected remaining seats.

In summary, the present invention displays reservation statuses of ticket resellers on one seating chart when there are a lot of ticket resellers for one kind of ticket, making it possible for the customer to easily inquire about the entire reservation status of one or more seats to be reserved or purchased. In addition, the customer may easily compare sales conditions between the ticket sales sites.

As a result, the customer may easily select the seats meeting his/her desired conditions, and may easily reserve the tickets after moving to the ticket sales site, on which tickets for the selected seats are sold, simply by selecting the seats.

While the invention has been shown and described with reference to certain exemplary embodiments thereof, it will be understood by those skilled in the art that various changes in form and details may be made therein without departing from the spirit and scope of the invention. For example, although the exemplary embodiment of the present invention provides not only a procedure for providing an integrated seating chart to the user, but also a procedure for proceeding with the payment process by user's selecting remaining seats and logging in the ticket sales site corresponding to the selected remaining sides, by way of example, in an alternative embodiment of the present invention, only the procedure for providing the integrated seating chart to the user may be applied to implement the present invention. Even in this case, the user may easily inquire about the entire reservation status simply by watching one screen, and may reserve tickets on a homepage of the ticket sales site on which tickets for his/her desired seats are sold. In addition, although the present invention has been described with reference to reservation of tickets for a public performance by way of example, the present invention may be applied in the same way even for reservations of tickets for sports events or transportation modes as long as there are a lot of ticket resellers for one kind of ticket.

Moreover, although in the exemplary embodiment of the present invention the reservation status information includes the seating chart and classes of seats by way of example, the seating chart and classes of seats may be excluded from the reservation status information. In this case, the terminal may quickly display the integrated seating chart by minimizing the delay in time for which the terminal receives reservation status information from the servers and handles the received reservation status information. To this end, seating charts and classes of seats for large popular venues or public performance halls or locations may be included by default in an application supporting the integrated ticket reservation of the present invention, or may be downloaded and stored in the terminal in advance.

In addition, the terminal may download a program (e.g., application) for supporting the integrated ticker reservation of the present invention from a remote program provisioning device (e.g., program server), or install the program in the terminal, and may run the downloaded/installed program, thereby making it possible for the user to use the program in integrated ticket reservation. In other words, if installed in a terminal, a program for integrated ticket reservation may run in the terminal, providing the integrated ticket reservation. The program server transmits the program to the terminal automatically or in response to a transmission request for the program from the terminal. Additionally, the program server may determine whether the terminal has subscribed to the service, may authenticate a user of the terminal, and may check payment information of the terminal The program server may include a communication unit for perform wire/wireless communication with the terminal, a storage medium for storing the program, and a controller for transmitting the program to the terminal through the communication unit. The storage medium may be located either inside or outside of the program server.

The above-described apparatus and methods according to the present invention can be implemented in hardware, firmware or as software or computer code that can be stored in a recording medium such as a CD ROM, a RAM, a ROM, a floppy disk, DVDs, a hard disk, a magnetic storage media, an optical recording media, or a magneto-optical disk or computer code downloaded over a network originally stored on a remote recording medium, a computer readable recording medium, or a non-transitory machine readable medium and to be stored on a local recording medium, so that the methods described herein can be rendered in such software that is stored on the recording medium using a general purpose computer, a digital computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, the program may be electronically transferred through any media such as communication signals transmitted by wire/wireless connections, and their equivalents.

Therefore, the scope of the present invention should not be limited to the above-described embodiments, but should be defined only in accordance with the following claims and their equivalents.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for integrated ticket reservation in a terminal, comprising:
receiving reservation target information for a reservation target from a user;
requesting a plurality of servers of preset ticket sales sites to provide reservation status information corresponding to the reservation target information;
receiving, from the servers, the reservation status information including seat status information indicating any remaining seats for the reservation target;
integrating the seat status information included in the reservation status information from each of the servers into a full seating chart for the reservation target; and
displaying the full seating chart on a screen.

2. The method of claim 1, further comprising:
allowing a user to select at least one of the remaining seats on the seating chart;
transmitting seat selection information for the selected at least one seat to a server corresponding to the at least one selected remaining seat; and
moving to a ticket sales site corresponding to the selected at least one seat.

3. The method of claim 2, wherein the reservation status information further includes price and discount information of a seat class associated with each seat;
wherein the allowing a user to select at least one of the remaining seats further comprises displaying the price and discount information of the selected seat on the screen.

4. The method of claim 1, wherein the reservation target information includes a name and date/time of a public performance when the reservation target is the public performance; and
wherein the full seating chart is a full seating chart of a public performance location where the public performance is scheduled to take place.

5. The method of claim 4, wherein the full seating chart and seat classes associated with the seats of the public performance location are stored in the terminal in advance.

6. A method for integrated ticket reservation in a server of a preset ticket sales site for integrated ticket reservation on a terminal, comprising:
receiving a request for reservation status information corresponding to reservation target information for a reservation target, from the terminal;
searching a reservation database for the reservation status information including seat status information indicating any remaining seats for the reservation target based on the reservation target information; and
transmitting the searched reservation status information to the terminal

7. The method of claim 6, further comprising performing a payment process depending on seat selection information, if the seat selection information is received from the terminal and a user of the terminal logs in.

8. The method of claim 6, wherein the reservation status information further includes price and discount information of a seat class associated with each seat.

9. The method of claim 6, wherein the reservation target information includes a name and date/time of a public performance when the reservation target is the public performance.

10. A terminal for providing an integrated ticket reservation, comprising:
a communication unit for communicating with a plurality of servers of preset ticket sales sites;
a display;
a key input unit; and
a controller for requesting the servers to provide reservation status information including seat status information indicating any remaining seats for a reservation target which is input by a user using the key input unit, receiving the requested reservation status information through the communication unit, integrating the seat status information included in the reservation status information from each of the servers into a full seating chart for the reservation target, and displaying the full seating chart on a screen of the display.

11. The terminal of claim 10, wherein if the user selects a remaining seat on the seating chart using the key input unit, the controller transmits corresponding seat selection information for the selected remaining seat to a server corresponding to the selected remaining seat through the communication unit, and moves to a ticket sales site corresponding to the selected remaining seat.

12. The terminal of claim 11, wherein the reservation status information further includes price and discount information of a seat class associated with each seat; and
wherein the controller displays the price and discount information of the selected remaining seat on the screen.

13. The terminal of claim 10, wherein the reservation target information includes a name and date/time of a public performance when the reservation target is the public performance; and
wherein the full seating chart is a full seating chart of a public performance location where the public performance is scheduled to take place.

14. The terminal of claim 13, wherein the full seating chart and seat classes associated with the seats of the public performance location are stored in the terminal in advance.

15. A server of a preset ticket sales site for integrated ticket reservation on a terminal, comprising:
a communication unit for communicating with the terminal;
a reservation database for storing reservation status information for a reservation target; and
a controller for, upon receiving a request for the reservation status information corresponding to reservation target information for the reservation target from the terminal through the communication unit, searching the reservation database for the reservation status information including seat status information indicating any remaining seats for the reservation target based on the reservation target information, and transmitting the searched reservation status information to the terminal through the communication unit.

16. The server of claim 15, wherein the controller performs a payment process depending on seat selection information, if the seat selection information is received from the terminal and a user of the terminal logs in.

17. The server of claim 15, wherein the reservation status information further includes price and discount information of a seat class associated with each seat.

18. The serer of claim 15, wherein the reservation target information includes a name and date/time of a public performance when the reservation target is the public performance.
